(19) United States
(12) Patent Application Publication
(10) Pub. No.: US 2008/0294517 A1
(43) Pub. Date: Nov. 27, 2008

(54) CUSTOMIZED IMAGE BASED CALENDAR, METHOD AND SYSTEM

(76) Inventor: Gregory Howard Hill, Laguna Niguel, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/753,950

(22) Filed: May 25, 2007

(51) Int. Cl. G06Q 30/00; G04B 19/00

(52) U.S. Cl. 705/14; 283/2; 705/1

(57) ABSTRACT

An advent calendar including a first sheet with a full color customized image and a plurality of apertures. Each aperture is associated with a movable door and the door is fastened to a perimeter of the aperture with a hinge element. A second sheet, including a reduced-color version of the customized image and at least one customized indicia. The first and second sheets are registeringly aligned so that the each of the plurality of apertures fully eclipse one of the customized indicia, such that each customized indicia is fully visible through an aperture when the movable door associated with the aperture is in an open orientation.

### BACKGROUND

The present invention relates to theme calendars and more specifically to customized thematic calendars. The prior art as shown in U.S. Pat. No. 5,443,288 discloses that calendars used simply for the marking of the passage of time have been known for millennia. The patent further discloses that many previous calendars have been designed which provide humorous, religious, or inspirational messages for a user associated with each day. For example, Christmas Advent calendars provide religious inspiration through messages and figures relating to the biblical teachings of the Christmas season. U.S. Pat. No. 5,443,288 further cites:

In U.S. Pat. No. 2,831,278, issued Apr. 22, 1958, R. H. Myers discloses a calendar structure which permits a user to write personal reminder messages under a moveable tab covering each date on the monthly calendar.

In U.S. Pat. No. 5,207,580, issued May 4, 1993, Victor J. Strecher discloses a calendar manufactured with customized textual messages relating to a specific health or behavior modification goal for a particular individual. Motivational messages as well as reminder messages are displayed in appropriate days of each related month. The specific days, months, and messages unique to the particular individuals behavior modification or health related goal.

In U.S. Pat. No. 5,090,733, issued Feb. 25, 1992, R. Bussiere discloses a calendar with inspirational and motivational messages indicating thoughts or actions for each day, the goal of which is to inspire self-improvement. The messages are printed on moveable tabs and relate to sections of a picture so that as messages are added or revealed, a picture is being constructed to inspire the user to fulfill a personal objective.

More recently U.S. Pat. No. 7,090,253 issued Aug. 15, 2006 discloses a customizable theme calendar including a set of date cells corresponding to an arbitrarily designated time period. Such calendars may be designed and generated in connection with a computer system and calendar generation software.

All of the above-mentioned systems fail to teach a calendar that is created online, created using customer supplied artwork, has a first color rich image and a second color-muted image and that the calendar can delivered to a recipient and correlated with a virtual calendar.

### SUMMARY OF THE INVENTION

In one embodiment, the present invention provides an advent calendar including a first sheet. The first sheet includes a full color customized image with a plurality of apertures cut into it. Wherein each aperture is associated with a movable door and the door is fastened to a perimeter of the respective aperture with a hinge element. A second sheet includes a reduced-color version of the customized image and a plurality of customized indicia. The customized indicium corresponds to the number of apertures. The first and second sheets are registeringly aligned so that the each of the plurality of apertures fully eclipse one of the customized indicia, such that the one customized indicia is fully visible through one aperture when the movable door is in an open orientation. Each door is associated with a specific date and when opened reveals the customized indicia which is generally written text, however in other embodiments the indicia could be delivered orally, musically, or could serve as a signal to a remote device which would display the message using human perceptible signals.

In one embodiment the calendar, is an advent calendar and the first sheet's customized image is a photograph, optionally captured using a digital camera. In some embodiment the apertures in the first sheet are uniformly sized, in other embodiments they are sized to accommodate the message, to signify the relative importance of the message.

In another embodiment the advent calendar wherein the hinge element is a living hinge, as used herein a living hinge is a hinge or flexure bearing without moving parts. While the hinge may be of thinner material to allow bending such need not be the case, in the case of a polymeric sheet, the hinge will generally include a thin section of the material that bends to allow movement, if paper or paper product is used the hinge may have no special pretreatment as the material is readily folded. It is contemplated that the customized indicia on the second sheet is exposed in the aperture when the door is opened.

In yet another embodiment of the advent calendar the first sheet includes a material backing comprised of at least one of the following: open celled foam, paper, cardboard, close celled foam, polymeric resin, polymeric sheeting, wood, glass, metal, and plastic. It is specifically contemplated that a plurality of materials may also be used, for instance a polymeric material coated with a metallic material is contemplated. In other embodiments, a wood fiber/cellulose may exist in a glue matrix. In other embodiments, a wood veneer may be used over a cardboard substrate.

In an embodiment the second sheet includes a material comprised of at least one of the following open celled foam, paper, cardboard, close celled foam, polymeric resin, polymeric sheeting, wood, glass, metal and plastic. It is contemplated that the second sheet would generally be more substantive than the first sheet and will generally be selected from less expensive materials. However, in some embodiments a polymeric printed circuit board may be included in the second sheet. It is contemplated that more costly materials would be recycled or reused. In some embodiments, the calendar after use could be converted to a photo album cover, a journal, a family portrait or other aesthetic or functional component or object.

The advent calendar, in yet another embodiment, has the first and second sheets registeringly aligned, and the apertures are sized to accommodate the area of the customized indicia. As such, the customized indicia are fully visible through the corresponding aperture when the movable door is in an open orientation.

One embodiment of the present invention provides a method for calendaring dates using a customized calendar. The method includes the steps of receiving data from a customer, building a physical calendar and building a virtual parallel calendar, shipping the physical calendar to a user and finally communicating data from the virtual parallel calendar to a recipient. The recipient uses data from the virtual parallel calendar to add value to the physical calendar. In operation, one embodiment of the method includes the steps of receiving a plurality of data including: an image, a chronological range, and context specific, date appropriate, customized data. The next step includes building a physical calendar including the steps of facilitating the selection of date specific data. This facilitation may be linked, most commonly, to the collection of the data but it also can be linked to a database with thematic data. In this step, in some embodiments material from a printing system is cut to create apertures and glued in registry over a second sheet. In the next step, building a virtual parallel calendar, at least one date is selected as a reminder for an activity or event described in the physical calendar. The next step is shipping the physical calendar to a user and communicating data from the virtual parallel calendar to a recipient, wherein the recipient uses data from the virtual parallel calendar to add value to the physical calendar. It is contemplated that the recipient will oftentimes be the customer, or an associate of the customer.

In another embodiment the method for calendaring dates using a customized calendar allows a consumer to provide a photograph, a child's painting or other work of art created by the consumer. Further, in some embodiments the chronological range is specified by the consumer. In some cases this may be the period of Lent, a period of a month or a period of less than or more than a month. The context specific, date appropriate, customized data can include birthdays, holidays, anniversaries, user defined special days. The lead up to the day may allow the consumer to prepare a story, such as a marriage proposal, fairly tale, poem, or other message. In another embodiment the story outline is provided to the customer and the story is suitable for customization, wherein names, ages, locations, expressions (including surprise, disappointment, pleasure, happiness, and sadness) may be added by the customer. Expressions, including street names, automobile types, room descriptions, furniture, siblings, spouses, friends and significant others may also be provided by the customer. In the situation where opening the door activates an audible recording and/or a visual recording the recording maybe made to play each time the door is opened. The recording may be made with the aid of a professional actor, the customer, a synthesizer, another person or a synthesizer. In the case where an actor's voice is used, the customized audible material could be added to an existing template, thereby obviating the need to re-record the entire story. The recording may be stored on an integrated circuit device, and the recording may include photographs or motion pictures, provided either by the customer or from stock footage stored in the virtual store.

In another embodiment the method for calendaring dates using a customized calendar of includes the step of building a physical calendar includes sizing the image to meet predetermined size requirements of the calendar. In some situations, the image sizing will require the addition of framing to make the image size comport with the calendar size, and printing a first and second copy of the image. It is contemplated that the first and second copies of the image have different relative color intensities. The apertures and associated doors are created on the first sheet. The context specific, date appropriate, customized data are added to the second sheet, such that the apertures, of the first sheet, fully eclipse the context specific, date appropriate, customized data when the doors are open.

The method for calendaring dates using a customized calendar includes an embodiment wherein the context specific, date appropriate, customized data is provided in part by a user and provided in part by a vendor using a database which includes certain types of data. Examples include at least one of the following: holidays or events traditionally observed in the United States, holidays or events traditionally observed in at least one of Korea, China, Japan or the Orient, days traditionally celebrated by Christians, Jews, or Muslims, and days traditionally observed by people residing in the European Union or one of its member states. In the case of certain countries, this might be a celebration of a first birthday, the celebration of the completion of a ceremonial undertaking or other event. Ramadan may also be celebrated with the aid of the calendar; the customized data include the times of sunrise and sunset at the location where the calendar is delivered. Other Ramadan related data might include reminders of pillars of the faith or religiously significant events.

In another embodiment the method for calendaring dates using a customized calendar wherein the context specific, date appropriate, customized data is provided in part by a user and provided in part by a vendor or virtual store using a database. The database includes at least one of the following: dates of historical significance in the United States, dates of historical significance in Korea, China, Japan, or the Orient; and dates of historical significance in the European Union or one of its member states.

In yet another embodiment the present invention provides a method for calendaring dates using a customized calendar wherein the context specific, date appropriate, customized data is provided in part by a user and provided in part by a vendor, or virtual store, using a database. The database includes at least one of: headlines of major publications, recordings on dates of international significance, dates of birth and death of major historical figures, and dates of significant legislative and judicial importance. An example might include the headlines of a major newspaper such as the New York Times, the Los Angeles Times, recordings might include radio broadcasts, television broadcasts, movie shorts, news clips etc. These historically significant data may be used as “fill” on days where the consumer does not have a date that the consumer what to have recorded.

Another embodiment of the present includes a system for delivering targeted advertising collecting customized data. The embodiment includes at least two of the following: an image, optionally a digital photographic image, a day of remembrance, optionally one of intimate or personal nature, a birthday, an anniversary, optionally a wedding anniversary, an employment anniversary, a five year anniversary of being cancer free, an anniversary of a life changing event or other anniversary, a religious holiday, a secular holiday; a day of pride, and a predetermined day of note. Thereafter this embodiment of the present invention creates a customized physical calendar including a customized board. The customized board includes a customized image, a plurality of doors, wherein each door corresponds to a calendar date, and a customized message is placed behind each door. The system sends a message to a predetermined location, before each calendar date, wherein the message offers at least one of contextually appropriate goods or contextually appropriate services.

In another embodiment the system for delivering targeted advertising the customized data includes the Christmas holiday and a predetermined day of note, and the message is an email message sent to an email address provided in connection with the purchase of the calendar. In yet another embodiment the system for delivering targeted advertising includes a component where the message is an email message sent to an email address provided in connection with the purchase of the calendar and the email message offers at least one of contextually appropriate goods and contextually appropriate services for sale. In a variant of this embodiment, or in other embodiments, the services are available for purchase and timely delivery by responsive email, in some cases charging the offered goods or services to the say payment vehicle used in ordering the calendar. In some embodiments the goods and services include flowers, gift certificates for dining, complete meal gift certificates which include any items on the menu, drinks, (buyer may select the number in advance) taxes, and gratuity.

One embodiment of the present invention provides a system for delivering targeted advertising wherein the message containing the targeted advertising is in the form of an email message sent to an email address, which was provided in connection with the purchase of the calendar. The email message offers at least one of contextually appropriate goods and contextually appropriate services for barter. In this manner some of the goods or services may be bartered, for instance childcare may be bartered between people who belong to a screening agency or club. This would be especially appropriate where services are concerned and trust is a critical requirement.

In another embodiment a system for delivering targeted advertising includes a message that is sent via email to an email address provided in connection with the purchase of the calendar and the email message offers contextually appropriate restaurant and entertainment services. The appropriateness could be ascertained from implicit and explicitly provided data. Further, sales, discounts, and incentives could also be provided. In some cases, the buyer may already have purchased a package, which includes a theatre show, dinner, and coffee at a small restaurant. The email message could be used to upsell, including, for instance, having a dozen roses at the table when the party arrives for dinner, or offering better seats at the theatre.

In another embodiment the system for delivering targeted advertising, the message is sent via a wireless electronic device and is a reminder to use a previously purchased service. The wireless electronic may be a device such as the BLACKBERRY® from Research in Motion or the TREO® from Palm. The wireless device might send a reminder stating “Reminder—Dinner tonight at the Brown Pelican 8 PM” the message might also include options for additional information such as “Directions” “Menu preview” “Confirm reservation.” Additionally the message might query: “Would you like tickets to the Show playing 1 mile from the restaurant?” Associated with this question could be the option to read reviews, get directions, locate nearby parking etc.

In another embodiment the system for delivering targeted advertising includes the option wherein the message is sent via a wireless electronic device and is a reminder to procure a previously purchased good. Like the embodiment described above, except with respect to goods. This might be a reminder to pick up a piece of jewelry, flowers, candy, tools, or other goods.

### BRIEF DESCRIPTION OF THE DRAWINGS

the present invention provides its benefits across a broad spectrum of commerce. While the description, which follows hereinafter, is meant to be representative of a number of such applications, it is not exhaustive. As those skilled in the art will recognize, the basic methods and apparatus taught herein can be readily adapted to many uses. It is applicant's intent that this specification and the claims appended hereto be accorded a breadth in keeping with the scope and spirit of the invention being disclosed despite what might appear to be limiting language imposed by the requirements of referring to the specific examples disclosed.

FIG. 1 is an embodiment of full color image of the calendar;

FIG. 2 is an embodiment of the muted color image of the calendar;

FIG. 3 is an example of the system of the present invention; and

FIG. 4 is a simplified embodiment of the method of the present invention.

### DETAILED DESCRIPTION

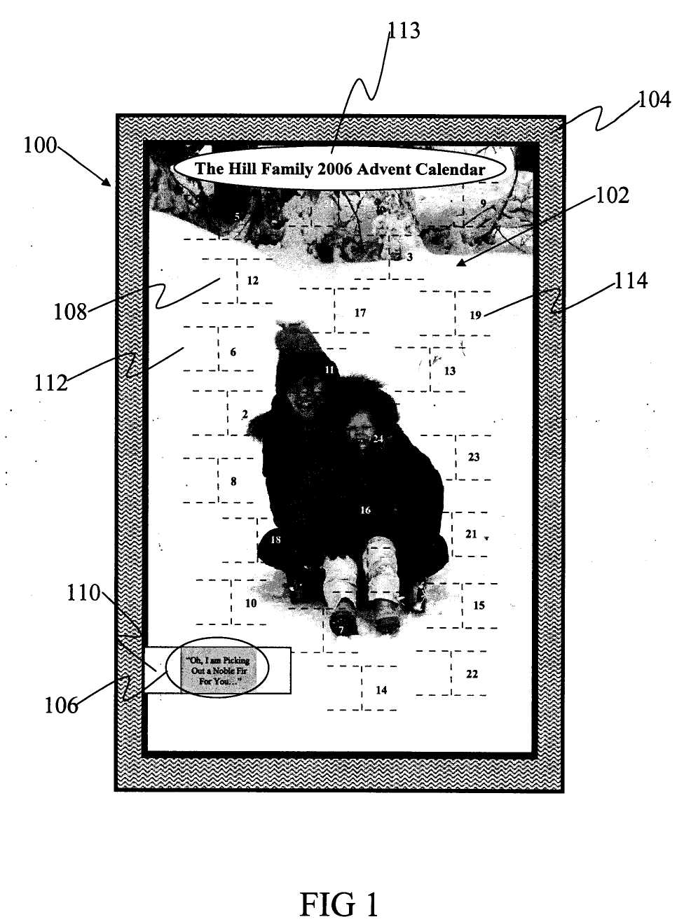

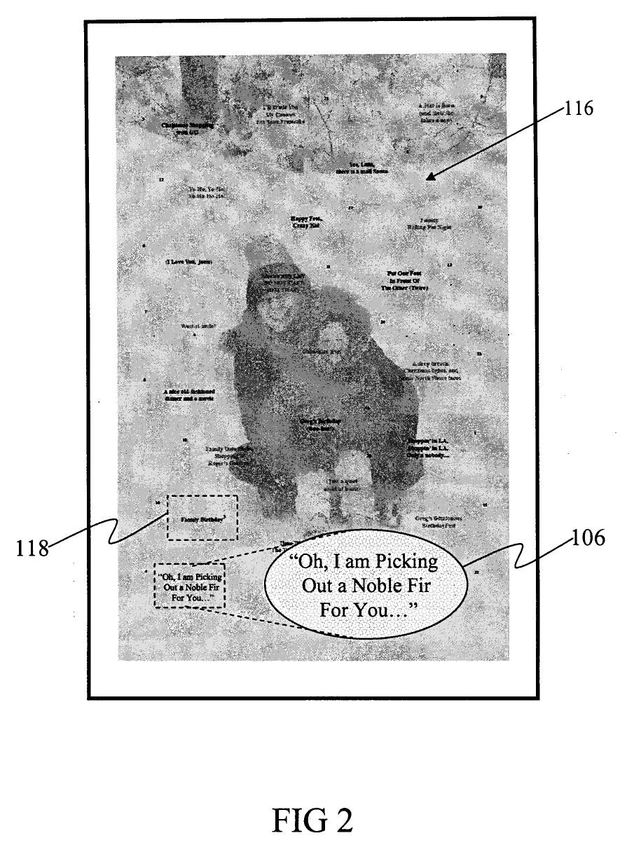

One embodiment of the present invention provides a calendar. FIGS. 1 and 2 illustrate one embodiment of the calendar 100. In this embodiment, a first image 102 is provided in full color—where full color is understood to mean in the manner as was originally provided. Full color need not refer to a plurality of colors; rather it is understood to mean that the first image 102 appears substantially as the artist intended the image to appear. A second image 116 is provided in muted colors, often halftones, or otherwise is sufficiently light/dark such that there is sufficient contrast between the second image 116 and the customized indicia 106. The relevant inquiry is whether the text or other customized indicia 106 appearing on the second image 116 is sufficiently contrasted. In one example, a photograph is provided as the first image 102. Customized indicia 106 is added to the second sheet in registered alignment with apertures 108 which are sized so as to fully eclipse the indicia 106. The second image 116 is affixed to the backside of the image 102. When the door 110 is opened, the customized indicia 106 printed on the second image 116 is revealed. In some cases the first image 102 may not be suitably dimensioned, or may be of a quality that does not properly allow for sufficient magnification. In such situations, a frame 104 may be provided. In FIG. 1, the frame 104 is fairly neutral, however it is contemplated that the frame 104 could take any number of characteristics. If the calendar 100 is related to Christmas, the frame 104 could be made to reflect a Christmas theme. The specific selection, beyond theme could also, optionally, be selected. Thus, a Christian, secular, or even, by way of example, a Santa Claus may be selected at the time the calendar 100 is ordered. In another embodiment, the frame 104 could be made to bisect the calendar 100 and, in some cases, a plurality of first images 102 could be provided in lieu of a single first image 102. It is further contemplated that the first image 102 will often include indicia 113 which is appropriate to the calendar, the recipient, or the calendar theme, in most embodiments this is a customized indicia. The indicia 113 may be placed anywhere, and may be fully customized. Each aperture 108 is associated with a door 110 or as illustrated a plurality of doors. It should be noted that a wide variety of door configurations are contemplated. In most embodiments, the door 110 includes a hinge 112 portion, in this case the hinge 112 is a flexure bearing with no moving parts. In some embodiments, this may result from a fold in a paper or paper product door 110. In such a case, the hinge 110 comes into existence when the door 110 is opened for the first time. Once the door 110 or doors are opened a reserved area 118 is exposed, within the reserved area 118 is the customized indicia 106. The door 110 is associated with a sequence indicator, in this case a date 114.

In another embodiment the door 110 is contoured and shares its interface at least one other door 110. In some embodiments the doors 110 may form an interlocking jigsaw puzzle. In such a case, the sequence in which the doors 110 are removed will need to be sequenced to ensure that there is continuity between a frame area and the doors 110. In one embodiment the removal sequence may originate from the center. Choice in adhesives holding the doors 110 may also obviate the need continuity with the frame.

In another embodiment when all the doors are removed another picture sheet is removed, or a plurality of other picture sheets are revealed. Further, the removed pieces could serve a jigsaw puzzle. In some versions the puzzle has a image on the front and a text message on the obverse. The text message may be augmented with an image as well. In such a case it is contemplated that the images would have an indicia indicating which piece is an obverse piece. This may be done with the text, dominant color, or other indicia.

In another embodiment the doors 110 constitute game pieces and may be removed to reveal prizes. In yet another embodiment initial image may be jumbled, and will only become recognizable one assembled in the correct sequence. In such a case the doors 110 would, in one embodiment, be square or rectangular.

In a further embodiment, an advent calendar including a first image 102 is provided. The first image 102 is adhesively associated with a substrate sheet. When assembled the sheet includes a full color, or otherwise complete, customized image 102 with a plurality of apertures 108 cut into it. Wherein each aperture 108 is associated with a movable door 110 and the door 110 is fastened to a perimeter of the respective aperture 108 with a hinge 112 element. A second image 116 is, optionally, adhesively associated with a sheet. The second image 116 includes a reduced-color version of the first customized image 102 and a plurality customized indicia 106. The customized indicia 106 correspond to the number of apertures. The first image 102 and second image 116 are registeringly aligned so that the each of the plurality of apertures 108 fullly eclipse one of the customized indicia, thus revealing the reserved area 118, such that the customized indicia 106 is fully visible through one aperture when the movable doors or door 110 is in an open orientation. Each door 110 is associated with a specific date and when opened reveals the customized indicia 106 which is generally written text. While text is a common choice, in other embodiments the customized indicia 106 could be a photograph or a message that is delivered orally, musically, or could serve as a signal to a remote device, which would display the message using human perceptible signals. Just as a story, proposal is a form that the text may take clues (as for a reward) or other indicia may be provided.

In another embodiment an advent calendar is provided, where it is understood that advent need not specifically refer to Christmas. In this embodiment the first image 102 is a photograph, optionally captured using a digital camera. In some embodiment the apertures 108 in the first image 102 are uniformly sized, in other embodiments they are sized to accommodate the customized indicia 106, or to signify the relative importance of the message, or otherwise to accommodate the content of the second image 116.

In a further embodiment the hinge 112 element is a living hinge, as used herein a living hinge is a hinge or flexure bearing without moving parts. While the hinge 112 may be of thinner material to facilitate bending such need not be the case. In the case of a polymeric sheet serving as a substrate for the first image 102, the hinge 112 will generally include a thin section of the material that bends to allow movement, if paper or paper product is used the hinge 112 may have no special pretreatment, as the material is readily folded. It is contemplated that the customized indicia 106 on the second sheet is confined to the reserved area 118 and exposed in the aperture 108 when the door 110 is opened. In another embodiment a unique image is revealed when each door is opened. Thus, the second sheet will have a plurality of unique images, each of which will be exposed, in turn, upon the opening of the doors.

In another embodiment the first image 102 includes a material backing comprised of at least one of the following: open celled foam, paper, cardboard, close celled foam, polymeric resin, polymeric sheeting, wood, glass, metal, and plastic. It is specifically contemplated that a plurality of materials may also be used. For instance, a polymeric material coated with a metallic material is contemplated. In other embodiments, a wood-fiber/cellulose mixture may exist in a glue matrix. In other embodiments, a wood veneer may be used over a cardboard substrate. Is such a case the first image 102 may include a wood veneer frame 104. The resultant calendar would have a heftier feel, and the appearance of a fine wooden work of art.

In another embodiment the second image 116 adhesively associated with a sheet that includes a material comprised of at least one of the following open celled foam, paper, cardboard, close celled foam, polymeric resin, polymeric sheeting, wood, glass, metal and plastic. It is contemplated that the second sheet would generally be more substantive than the first sheet and also will generally be selected from less expensive materials. However, in some embodiments a polymeric based printed circuit board, and associated circuits, may be included in the second sheet. It is contemplated that more costly materials would be recycled or reused. In some embodiments, the calendar 100, after use, could be converted to a photo album cover, a journal, a family portrait or other aesthetic or functional component or object.

In yet another embodiment, the first image 102 and second image 116 are registeringly aligned and the apertures 108 are sized to accommodate the reserved area 118 thereby allowing the customized indicia 106 to be viewed when the doors 110 are opened. As such, the customized indicia 106 are fully visible through the corresponding aperture when the movable door is in an open orientation.

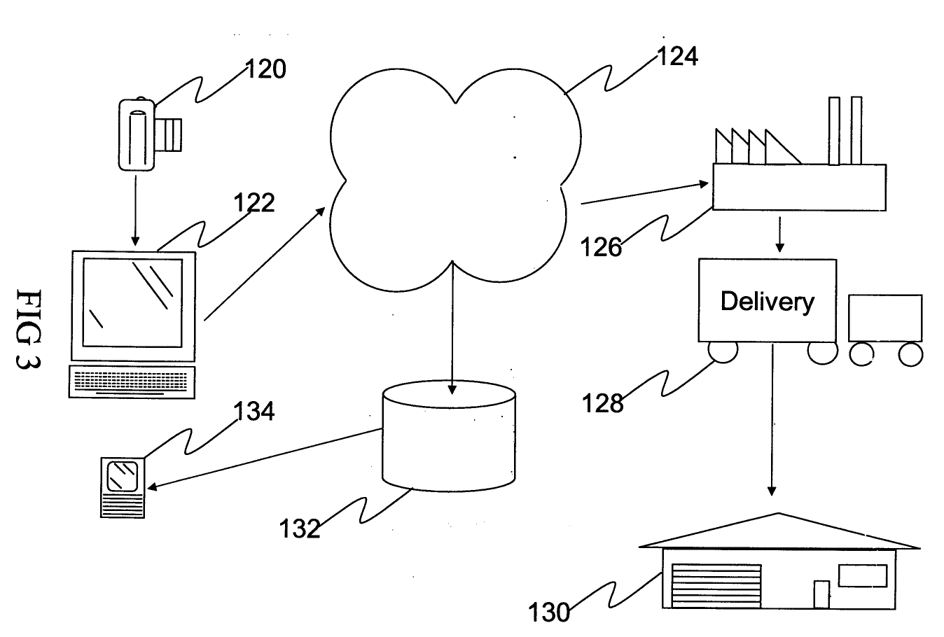

In another embodiment of the present invention, as illustrated in FIG. 3 an image capture device 120 is provided, in many instances the image capture device 120, is a CCD camera, or other electronic camera. However, the expression image capture device should not be construed so narrowly. A set of markers and a sheet of paper could serve as an image capture device 120 as well. Further, in certain limited situations existing images may be subjected to a scanner, which is also an image capture device 120. The use of pre-existing images, while possible will generally be avoided unless the images were created by the customer, or the vendor can otherwise obtain proper permission to use the image 102. Of primary importance is the image capture devices ability to capture images, preferably in electronic form, or a form that can be converted into electronic form. Additionally, an upload terminal 122 or other means for conveying images electronically, and including some form of data entry, or user interface component such as a keyboard is required.

In operation the image 102 is uploaded to the virtual store 124 and the customer, with the aid of the user interface component interactively creates a customized calendar 100. Customization can include such things as number of days, events, personal reminders, birthdays as well as virtually any other event, day, or message. Further, the customization might include the choice of a frame, layout, including orientation, or the calendar 100. In some embodiments the virtual store will allow for the modification of the image 102 to, optionally correct such things as exposure, red-eye, closed eyes, open mouths, and other imperfections. In some other embodiments, the virtual store 124 will allow for the addition of the likeness of a celebrity, the addition of a background or the addition of props. Other optional customization includes thematic suggestions for customized indicia 106. This might include, trivia, historical data, especially historical data corresponding to a theme and having significance for the particular date. The suggested customized indicia, may also be tied to input data, for instance, a birthday calendar could include data on the person's birth year according to another culture's calendar, for instance if the person was born in 1981 they may be from the year of the Rooster. Facts relating to the persons predicted compatibilities, strengths, weaknesses, and characteristics could be provided as part of the customized indicia. In another embodiment entertainment data such as horoscopes based on birth year and calendar 100 date could be the basis for theme. In another embodiment, the calendar 100 could serve as a means of calendaring surprise social activities, such as shopping trips, excursions, evenings together etc. Other customization might include the choice of materials for the calendar 100 and in some cases the addition of electronics to the calendar 100. After the customization is complete, the customer may be asked to confirm that the calendar is correct. Once confirmed, if this step is included, the data for the calendar is conveyed to a factory 126 for manufacturing. Once manufactured, the physical product is delivered, via a delivery system 128 to a recipient 103 who was designated by the customer. In the case of a gift, or for other reasons, the customer may select a date for the delivery of the calendar 100. In concert with customization of the calendar 100 which is delivered to the recipient 130 a virtual calendar 134 is created. The virtual calendar 132 sends reminders to a communication device, this might include text message to a cell phone, email, and email to a wireless device. One of the first messages might include a confirmation that the calendar was delivered. The virtual calendar provides reminders regarding the content of the calendar. If the calendar 100 discloses that March 17 will include dinner at a specific restaurant the reminder might include an invitation to make a reservation, offer directions, offer to have flowers or a special bottle of wine delivered to your table or otherwise offer goods or services which are contextually relevant. The communication schedule may be set at the time that the calendar 100 is being customized. Further, the customer may choose to make reservations, or pay for other goods and services at the time the calendar is being customized. In such cases, the communications may be limited to reminders, or offers for directions, or offers for additional complementary goods and services.

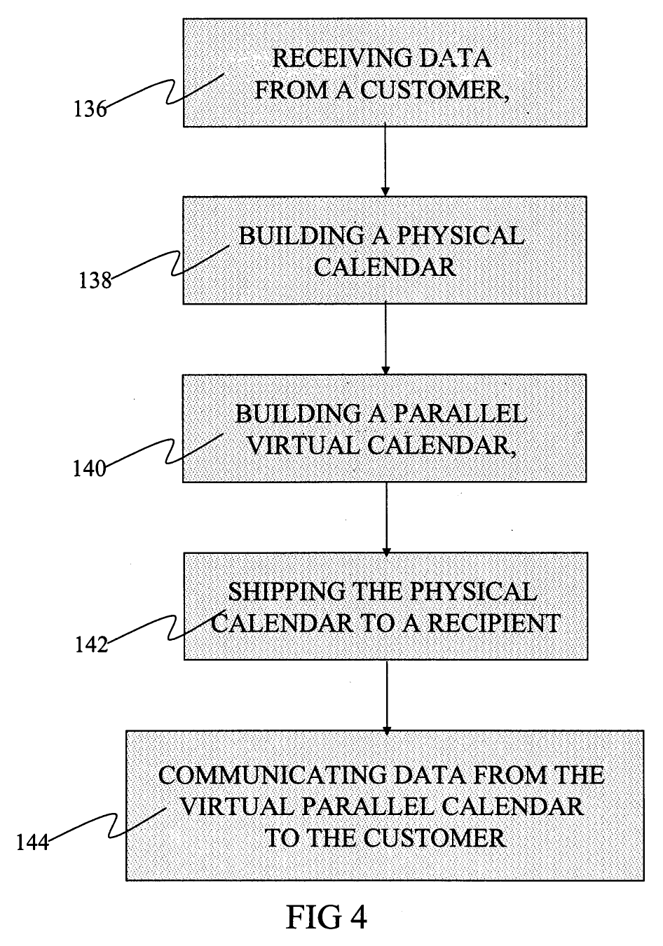

In another embodiment of the present invention, as shown in FIG. 4 a method for calendaring dates using a customized calendar is provided. The method includes the steps of receiving data from a customer 136, building a physical calendar 138, building a parallel virtual calendar 140, shipping the physical calendar to a recipient 142 and communicating data from the virtual parallel calendar to a customer 144. The customer may use the data from the virtual parallel calendar to add value to the physical calendar.

In operation, one embodiment of the method includes the steps of receiving a plurality of data including: an image 102, a chronological range, and context specific, date appropriate, customized data. The next step includes building a physical calendar including the steps of facilitating the selection of date specific data, this selection process may be facilitated by at least one thematic database a questionnaire and prompting. This facilitation may be linked, most commonly, to the collection of the data but it also can be linked to a database with thematic data. In this step, in some embodiments material from a printing system is cut to create apertures 108 and glued in registry over a second sheet. In the next step, building a virtual parallel calendar, at least one date is selected as a reminder for an activity or event described in the physical calendar 100. The next step is shipping the physical calendar 100 to a recipient and communicating data from the virtual parallel calendar to a consumer, wherein the consumer uses data from the virtual parallel calendar to add value to the physical calendar 100. It is contemplated that, in some cases, the customer may be the recipient or one of the recipients.

In another embodiment the method for calendaring dates using a customized calendar 100 allows a consumer to provide a photograph, a child's painting or other work of art created by the consumer or an acquaintance of the consumer. Further, in some embodiments the chronological range is specified by the consumer. In some cases this may be the period of Lent, a period of a month or a period of less than or more than a month. The context specific, date appropriate, customized data can include birthdays, holidays, anniversaries, user defined special days. The lead-up to the day may allow the consumer to prepare a story, such as a marriage proposal, fairly tale, poem, or other message. In the case of a marriage proposal the final day may include, behind the door 110 a ring. Similarly, sporting tickets or other objects could be stored in the calendar. In some cases, the objects will be put in the calendar at the time of manufacture, in other cases the objects will be added after delivery. Generally, the choice of the object is fully customizable, and may be selected from a predetermined list, including an appropriate thematic list, where the theme, may include a price component.

In another embodiment the method for calendaring dates using a customized calendar includes the step of building a physical calendar includes sizing the image 102 to meet predetermined size requirements of the calendar 100. In some situations, the image sizing will require the addition of framing 104 to make the image size comport with a predetermined calendar size. Another step is the printing of a first image 102 and a second image 116, wherein the first and second images have different relative color intensity. Thereafter, an aperture 108 may be created, said apertures 108 being associated with doors 110 on the first image 102 and adding context specific, date appropriate, customized indicia 106 to the second image 116, such that the apertures 108 fully eclipse context specific, date appropriate, customized data when the doors 110 are open. Determination of file type and file size is the first step in determining the image quality and what is the possible size that will be ultimately be used. In one embodiment the consumer will have the opportunity to override the maximum recommended size, or to reduce the image size.

In another embodiment, the method for calendaring dates using a customized calendar 100 includes an embodiment wherein the context specific, date appropriate, customized data 106 is provided in part by a consumer and provided in part by a vendor via the virtual store 124. The vendor/virtual store uses a database which includes at least holidays or events traditionally observed in the United States, holidays or events traditionally observed in Korea, China, Japan or the Orient, days traditionally celebrated by at least one of: Christians, Jews, or Muslim, and days traditionally observed in the at least one of the European Union or one of its member states.

In another embodiment, the method for calendaring dates using a customized calendar 100 wherein the context specific, date appropriate, customized data 106 is provided in part by a consumer and provided in part by a vendor via the virtual store 124. The vendor or virtual store uses a database that includes dates of historical significance in the United States, dates of historical significance in at least one of Korea, China, Japan, or the Orient; and dates of historical significance in the European Union or one of its member states.

In yet another embodiment the present invention provides a method for calendaring dates using a customized calendar 100 wherein the context specific, date appropriate, customized data 106 is provided in part by a consumer and provided in part by a vendor. The vendor or virtual store uses a database that includes at least one of: headlines of major publications recording on dates of international significance, dates of birth and death of major historical figures, and dates of significant legislative and judicial importance. Another embodiment of the present includes a system for delivering targeted advertising and collecting customized data. The collected data include at least two of the following: an image 102, optionally a digital photographic image, a day of remembrance, optionally one of intimate or personal nature, a birthday, an anniversary, optionally a wedding anniversary, an employment anniversary, a five year anniversary of being cancer free, an anniversary of a life changing event or other anniversary, a religious holiday, a secular holiday; a day of pride, and a predetermined day of note. Thereafter this embodiment of the present invention creates a customized physical calendar including a customized board. The customized board includes customized indicia 102, a plurality of doors 110, wherein each door 110 corresponds to a calendar date, and a customized message 106 is placed behind each door 110. The system sends a message to a predetermined location, before each calendar date, wherein the message offers at least one of contextually appropriate goods or contextually appropriate services.

In another embodiment the system for delivering targeted advertising the customized data includes the Christmas holiday and a predetermined day of note, and the message is an email message sent to an email address provided in connection with the purchase of the calendar. In another embodiment, the system for delivering targeted advertising includes a component where the message is an email message sent to an email address provided in connection with the purchase of the calendar and the email message offers at least one of contextually appropriate goods and contextually appropriate services for sale. In a variant of this embodiment or in other embodiments the services are available for purchase and timely delivery by responsive email, in some cases charging the offered goods or services to the same payment vehicle used in ordering the calendar. In some embodiments the goods and services include flowers, gift certificates for dining, complete meal gift certificates which include any items on the menu, drinks, (buyer may select the number in advance) taxes, and gratuity.

An embodiment of the present invention provides a system for delivering targeted advertising wherein the message containing the targeted advertising is in the form of an email message sent to an email address which was provided in connection with the purchase of the calendar. The email message offers at least one of contextually appropriate goods and contextually appropriate services for barter. In this manner, some of the goods or services may be bartered, for instance childcare may be bartered between people who belong to a screening agency or club. This would be especially appropriate where services are concerned and trust is a critical requirement.

In another embodiment a system for delivering targeted advertising includes a message that is sent via email to an email address provided in connection with the purchase of the calendar and the email message offers contextually appropriate restaurant and entertainment services. The appropriateness could be ascertained from implicit and explicitly provided data. Further, sales, discounts, and incentives could also be provided. In some cases, the buyer may already have purchased a package, which includes a theatre show, dinner, and coffee at a small restaurant. The email message could be used to upsell, including, for instance, having a dozen roses at the table when the party arrives for dinner, or offering better seats at the theatre.

In another embodiment the system for delivering targeted advertising, the message is sent via a wireless electronic device and is a reminder to use a previously purchased service. Wireless devices with functionality similar to devices such as the BLACKBERRY® from Research in Motion or the TREO® from Palm are specifically contemplated. The wireless device might send a reminder stating “Reminder—Dinner tonight at the Brown Pelican 8 PM” the message might also include options for additional information such as “Directions” “Menu preview” “Confirm reservation.” Additionally the message might query: “Would you like tickets to the Show playing 1 mile from the restaurant?” Associated with this question could be the option to read reviews, get directions, locate nearby parking etc. In another embodiment, the system for delivering targeted advertising includes the option wherein the message is sent via a wireless electronic device and is a reminder to procure a previously purchased good. Like the embodiment described above, except with respect to goods. This might be a reminder to pick up a piece of jewelry, flowers, candy, tools, or other goods.

What have been described are embodiments in which modifications and changes may be made without departing from the spirit and scope of the accompanying claims. Clearly, many modifications and variations of the present invention are possible in light of the above teachings. It is therefore to be understood that, within the scope of the appended claims, the invention may be practiced otherwise than as specifically described.

What is claimed is:

1. An advent calendar comprising:
a first sheet including a full color customized image with a plurality of apertures and each aperture is associated with a movable door and the door being fastened to a perimeter of the aperture with a hinge element;
a second sheet including
a plurality customized indicia; and
said first and second sheets are registeringly aligned so that the each of the plurality of apertures fully eclipse one of the customized indicia, such that each customized indicia is fully visible through an aperture when the movable door associated with the aperture is in an open orientation.

2. The advent calendar of claim 1 wherein the first sheet customized image is a photograph, and the apertures in the first sheet are substantially uniformly sized.

3. The advent calendar of claim 1 wherein the hinge element associated with each aperture is a living hinge, and the customized indicia on the second sheet is exposed in the aperture when the door is opened.

4. The advent calendar of claim 1 wherein the first image includes a material backing sheet comprised of at least one of the following:
open celled foam;
paper;
cardboard;
close celled foam;
polymeric resin;
polymeric sheeting;
wood;
glass;
metal; and
plastic

5. The advent calendar of claim 1 wherein the second sheet is comprised of at least one of the following:
open celled foam;
paper;
cardboard;
close celled foam;
polymeric resin;
polymeric sheeting;
wood;
glass;
metal; and
plastic.

6. The advent calendar of claim 1 wherein the first and second sheets are registeringly aligned, and the apertures are sized to accommodate the area of the customized indicia and wherein second sheet has a reduced color version of the customized image making the customized indicia fully visible through the corresponding aperture, and a portion of the reduced color version of the customized image when the movable door is in an open orientation.

7. The advent calendar of claim 1 wherein the first and second sheets are registeringly aligned, and the apertures are each sized to reveal a unique image on said second sheet, and each aperture is associated with one unique image on said second sheet.

8. A method for calendaring dates using a customized calendar including the steps of:
i. receiving a plurality of data including:
an image;
a chronological range: and
context specific, date appropriate, customized data;
ii. building a physical calendar including the steps of:
facilitating the selection of date specific data;
iii. building a virtual parallel calendar including the steps of:
selecting at least one date as a reminder for an activity or event described in the calendar;
iv. shipping the physical calendar to a recipient and communicating data from the virtual parallel calendar to a customer,
wherein the customer uses data from the virtual parallel calendar to add value to the physical calendar.

9. The method for calendaring dates using a customized calendar of claim 7, wherein:
the image is a photograph, the chronological range is less than 32 days and the context specific, date appropriate, customized data includes at least one of:
birthdays, holidays, anniversaries, user defined special days.

10. The method for calendaring dates using a customized calendar of claim 7, wherein:
the step of building a physical calendar includes sizing the image to meet the size requirements of the calendar, adding any necessary framing to make the image size comport with the calendar size and printing a first and second copy of the image, wherein the first and second copies have different relative color intensity;
creating apertures with doors on the first image and adding the context specific, date appropriate, customized data to the second image, such that the apertures of the first image fully eclipse context specific, date appropriate, customized data when the doors are open.

11. The method for calendaring dates using a customized calendar of claim 7, wherein:
the context specific, date appropriate, customized data is provided in part by a user and provided in part by a vendor using a database, which includes at least one of:
holidays or events traditionally observed in the United States;
holidays or events traditionally observed in at least one of Korea, China, or Japan;
days traditionally celebrated by at least one of: Christians, Jews, or Muslims; and
days traditionally observed in the at least one of the European Union or one of its member states.

12. The method for calendaring dates using a customized calendar of claim 7, wherein:
the context specific, date appropriate, customized data is provided in part by a user and provided in part by a vendor using a database which includes at least one of:
dates of historical significance in the United States;
dates of historical significance in at least one of Korea, China, or Japan; and
dates of historical significance in the European Union or one of its member states.

13. The method for calendaring dates using a customized calendar of claim 7, wherein:
the context specific, date appropriate, customized data is provided in part by a user and provided in part by a vendor using a database, which includes at least one of:
headlines of major publications recording on dates of international significance;
dates of birth and death of major historical figures; and
dates of significant legislative and judicial importance.

14. A system for delivering targeted advertising comprising:
i. collecting customized data including at least two of:
an image;
a day of remembrance;
a birthday;
an anniversary;
a religious holiday;
a secular holiday;
a day of pride; and
a predetermined day of note;
ii. creating a customized physical calendar including:
a customized board including a customized image;
a plurality of doors on the customized board, each door corresponding to a calendar date; and
a customized message behind each door;
iii. sending a message to a predetermined location, before each calendar date, wherein the message offers at least one of contextually appropriate goods or contextually appropriate services.

15. The system for delivering targeted advertising of claim 13 wherein the customized data includes Christmas and a predetermined day of note, and the message is an email message sent to an email address provided in connection with the purchase of the calendar.

16. The system for delivering targeted advertising of claim 13 wherein the message is an email message sent to an email address provided in connection with the purchase of the calendar and the email message offers at least one of contextually appropriate goods and contextually appropriate services for sale.

17. The system for delivering targeted advertising of claim 13 wherein the message is an email message sent to an email address provided in connection with the purchase of the calendar and the email message offers at least one of contextually appropriate goods and contextually appropriate services for barter.

18. The system for delivering targeted advertising of claim 13 wherein the message is an email message sent to an email address provided in connection with the purchase of the calendar and the email message offers contextually appropriate restaurant and entertainment services.

19. The system for delivering targeted advertising of claim 13 wherein the message is sent via a wireless electronic device and is a reminder to use a previously purchased service.

20. The system for delivering targeted advertising of claim 13 wherein the message is sent via a wireless electronic device and is a reminder to procure a previously purchased good.
